(19) United States
(12) Patent Application Publication
(10) Pub. No.: US 2026/0167138 A1
(43) Pub. Date: Jun. 18, 2026

(54) VEHICLE WITH DESIGN COVER

(71) Applicant: KAWASAKI MOTORS, LTD., Akashi-shi (JP)

(72) Inventors: Kouji ITOU, Akashi-shi (JP); Hidefumi YASUHARA, Akashi-shi (JP); Kota HIDAKA, Akashi-shi (JP)

(73) Assignee: KAWASAKI MOTORS, LTD., Akashi-shi (JP)

(21) Appl. No.: 18/980,090

(22) Filed: Dec. 13, 2024

(51) Int. Cl. B60R 19/52; B60R 13/00

(52) U.S. Cl. CPC B60R 19/52; B60R 13/005; B60R 2019/525

(57) ABSTRACT

A vehicle includes a vehicle body, a dashboard, a first design cover, and a second design cover. A seat is supported by the vehicle body. The dashboard is disposed in a front end of an occupant space in which the seat is disposed. The first design cover includes an inner design part located in front of the dashboard. A second design cover includes an outer design part located in front of the inner design part.

### TECHNICAL FIELD

The present disclosure relates to a vehicle with a design cover.

### BACKGROUND ART

US 2015/0090510 A1 discloses a rough terrain vehicle with a front cover.

### SUMMARY

A vehicle is a vehicle including: a vehicle body; a seat supported by the vehicle body; a dashboard disposed in a front end of an occupant space in which the seat is disposed; a first design cover including an inner design part located in front of the dashboard; and a second design cover including an outer design part located in front of the inner design part.

According to the vehicle, a design of a front surface of the vehicle is easily changed by the outer design part of the second design cover. In developing a vehicle with a plurality of models, set are a vehicle of a model with no second design cover and a vehicle of a model with the second design cover, and the inner design part of the first design cover is commonalized in the vehicle with the models; thus, increase in cost can be suppressed.

The objects, features, aspects, and advantages of this disclosure will become more apparent from the following detailed description and the accompanying diagrams.

### BRIEF DESCRIPTION OF DRAWINGS

FIG. 1 is a side view illustrating a vehicle.

FIG. 2 is a front perspective view illustrating a front part of the vehicle.

FIG. 3 is an exploded perspective view illustrating a front design cover.

FIG. 4 is a back perspective view illustrating the front design cover.

FIG. 5 is a front view illustrating a second design cover.

FIG. 6 is a cross-sectional view along an VI-VI line in FIG. 5.

FIG. 7 is a back perspective view illustrating a lower part the front part of the vehicle.

FIG. 8 is a front perspective view illustrating a front side part of a vehicle with no second design cover.

### DESCRIPTION OF THE PREFERRED EMBODIMENTS

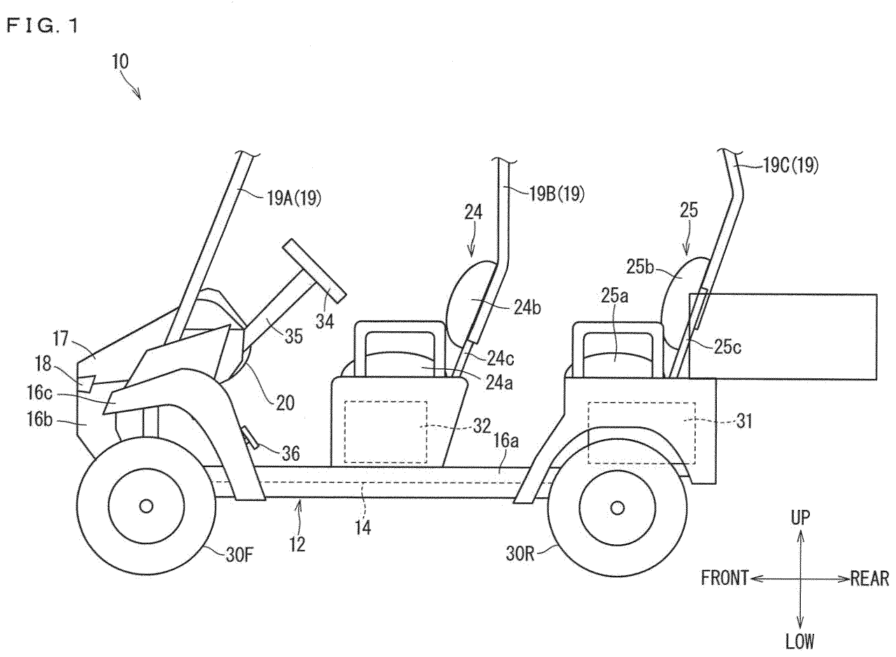

A vehicle according to an embodiment will be hereinafter described. FIG. 1 is a side view illustrating a vehicle 10. In the following description, a travel direction of the vehicle 10 may be expressed as FRONT, a direction opposite to the travel direction may be expressed as REAR, a road surface side on which the vehicle 10 travels may be expressed as LOW, and a side opposite to the road surface side may be expressed as UP. The RIGHT-LEFT may be referred to while a person stands on a road surface and faces forward. A right-left direction is a vehicle-width direction. A lateral side of a member indicates a position on a left side or a right side of the member.

The vehicle 10 may be a single-seated vehicle or a vehicle for occupants. The vehicle 10 may include only one seat in a front-back direction, or may also include seats. Since the vehicle 10 is a vehicle for a purpose of traveling on a driveway or a private road at a low speed, for example, entrances on right and left sides of a seat may be opened without being obstructed by walls or doors so that an occupant can easily get in and out of the vehicle 10. Here, the occupant can walk past in a right-left direction without being obstructed by doors or walls.

### Whole Configuration of Vehicle

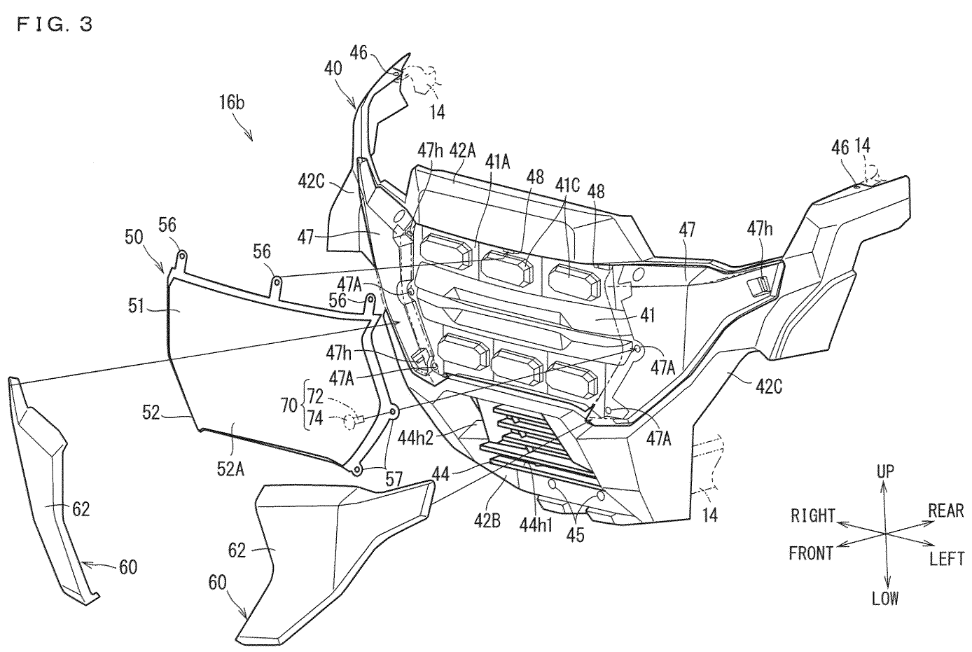

The vehicle 10 includes a vehicle body 12, a first design cover 40 (refer to FIG. 3) and a second design cover 50 (refer to FIG. 3). In the present embodiment, the vehicle 10 further includes seats 24 and 25, a travel mechanism, and a drive operation mechanism.

The vehicle body 12 may have a frame structure or a monocoque structure. The description in the present embodiment is based on an assumption that the vehicle body 12 has a frame structure. The vehicle body 12 includes a frame 14 and a panel. The frame 14 is structured by combining, for example, metallic pipe components, board metal components, or cast components. The panels cover the frame 14 and various components supported by the frame 14. The panel constitutes an outer appearance of the vehicle 10, and partitions spaces in the vehicle 10. Examples of the panels include a floor panel 16a, a front design cover 16b, a side panel 16c, a hood 17, and a dashboard 20.

The floor panel 16a is disposed in a lower part of an occupant space in which a driver and a passenger are located. The dashboard 20 is disposed in a front end of the occupant space. The dashboard 20 serves as a partition wall partitioning a front inner space located in front of the occupant space and the occupant space. The front design cover 16b and the side panel 16c are disposed in the front part of the vehicle 10. The front design cover 16b and the side panel 16c form an outer appearance of a front surface and a side surface of the vehicle 10. The front design cover 16b is provided to a part including a center of the vehicle 10. The pair of side panels 16c are provided on right and left sides of the vehicle 10. The front design cover 16b serves as a partition wall partitioning a front side of the front inner space. The first design cover 40 and the second design cover 50 form a part of the front design cover 16b. The side panel 16c serves as a partition wall partitioning a lateral side of the front inner space.

The hood 17 is located in front of the dashboard 20. The hood 17 serves as a partition wall partitioning an upper side of the front inner space. The front design cover 16b is located in a lower part of a front side of the hood 17. The pair of side panels 16c are located on both outer sides of the hood 17 in the right-left direction.

A dashboard, a glove box, various switches, or an indicator may be provided to the dashboard 20. The dashboard 20 according to the present embodiment includes an upper surface part located on an upper side of a floor panel region in which toes of a driver and a passenger are disposed.

The seats 24 and 25 are parts on which an occupant is seated. The seats 24 and 25 are located on the floor panel 16a. The seats 24 and 25 are supported by the vehicle body 12. The seats 24 and 25 are located away from each other in a front-back direction. The seat 24 is located in front of the seat 25. The seat 24 includes a seat cushion 24a, a backrest cushion 24b, and a seat frame 24c. In the similar manner, the seat 25 includes a seat cushion 25a, a backrest cushion 25b, and a seat frame 25c. The seat frames 24c and 25c can also be considered as a part of the frame 14 in the vehicle body 12. Outer right and left sides of the seats 24 and 25 are opening parts through which the occupant gets in and out of the vehicle 10. The vehicle 10 is intended to normally travel with the opening part being opened and not closed by, for example, a door.

Each of the seats 24 and 25 is a bench seat on which persons are seated side by side in a vehicle width direction. A driver seat on one side in the vehicle width direction and a passenger seat on the other side in the vehicle width direction are disposed with a center in the vehicle width direction therebetween. Herein, one side in the vehicle width direction in relation to a center in the vehicle width direction of the seat 24 is considered the driver seat, and the other side thereof is considered the passenger seat. The seat 24 may have a configuration that the driver seat and the passenger seat are provided independently from each other.

The travel mechanism is a mechanism for the vehicle 10 to travel, and includes wheels 30F and 30R, a travel motor 31, and a power transmission mechanism. Transmission of rotation drive force of the travel motor 31 to the wheels 30F and 30R through the power transmission mechanism allows the vehicle 10 to travel. Described in the present embodiment is an example that the vehicle 10 includes four wheels 30F and 30R. The vehicle 10 may include three wheels, or may also include six wheels. The configuration of the power transmission mechanism is discretionary. Examples of the power transmission mechanism may include a transmission and a drive shaft.

The wheels 30F and 30R include front wheels 30F and rear wheels 30R. Two front wheels 30F are rotatable around its own central axis and are supported to be rotatable around a steering axis at right and left front parts of the vehicle body 12. The two rear wheels 30R are supported to be rotatable around its own central axis at right and left rear parts of the vehicle body 12.

In the present embodiment, the travel motor 31 is an electrical motor converting electrical energy into rotational motion for traveling. In this case, the vehicle 10 includes a travel battery 32 for supplying the electrical energy to the travel motor 31. For example, the travel battery 32 is supported at a lower part of the seat 24, and the travel motor 31 is supported at a lower part of the seat 25. The travel motor 31 may be an internal combustion engine which burns fuel in a combustion chamber and generates power for traveling through expansion of gases from the burnt fuel. In this case, it is sufficient that the vehicle 10 includes a fuel tank. The positions of the travel motor 31 and the travel battery 32 are discretionary.

The drive operation mechanism is a mechanism for receiving a drive operation of a driver, and includes a steering wheel 34 and a pedal 36, for example. The driver operates the steering wheel 34, thereby being able to rotate the front wheels 30F around the steering axis. The driver operates the pedal 36, thereby being able to perform an acceleration operation and a brake operation. The steering wheel 34 and the pedal 36 are located in front of the seat 24. The driver seated on the seat 24 can operate the steering wheel 34 and the pedal 36. A steering column 35 protrudes backward from the dashboard 20, and the steering wheel 34 is supported on a distal end of the steering column 35, for example. The pedal 36 is located below the steering wheel 34. The pedal 36 may be an accelerator pedal and a brake pedal which are separately provided. It is applicable that both the acceleration and the brake can be operated with one pedal.

In the present embodiment, the vehicle 10 includes a pillar 19. The pair of pillars 19 are disposed on right and left sides, and upper end portions thereof are connected at a crossing part. Herein, a front pillar 19A, an intermediate pillar 19B, and a rear pillar 19C are provided as the pillars 19. The front pillar 19A extends to an upper side from both lateral sides of the dashboard 20. An upper surface part of the dashboard 20 protrudes in back of the pillar 19A. The intermediate pillar 19B extends from a backrest of the seat 24 toward the upper side. The rear pillar 19C extends from a rear side of the backrest cushion 25b toward the upper side. Upper end portions of the pillars 19A, 19B, and 19C may be connected at the crossing part. The intermediate pillar 19B or the rear pillar 19C may extends from a part such as a floor part other than the seats 24 and 25. The number of the pillars 19 is discretionary. Thus, for example, the intermediate pillar 19B may be omitted.

A roof not shown in the diagrams may be supported at an upper part of the pillar 19. In this case, the vehicle 10 may include the roof. The roof extends to cover the seats 24 and 25 from the upper side at a position on the upper side of the seats 24 and 25. The roof can protect the occupant from the sun and rain. In a front-back direction, the roof may extend from a position in front of the steering wheel 34 to a position in back of the backrest of the seat 25. In the right-left direction, the roof may extend to cover the whole seats 24 and 25 in the right-left direction.

### Configuration of Front Part of Vehicle

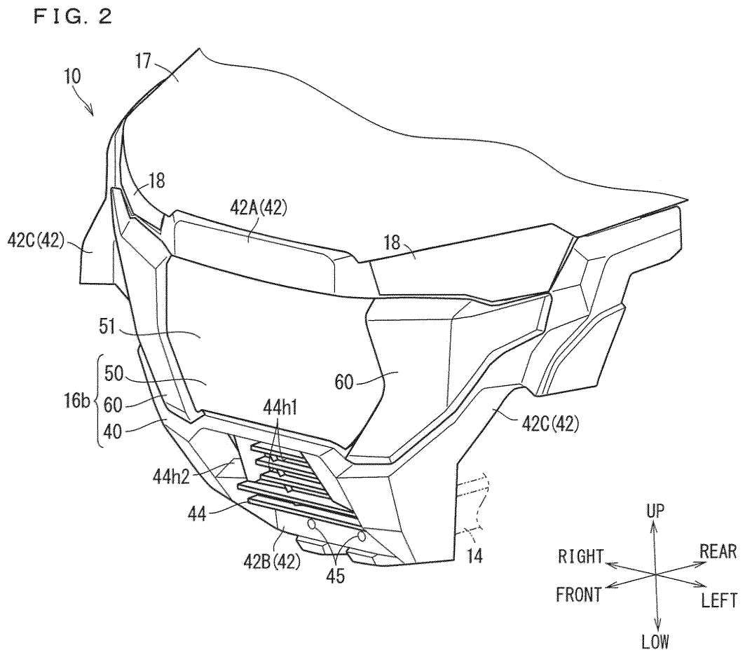

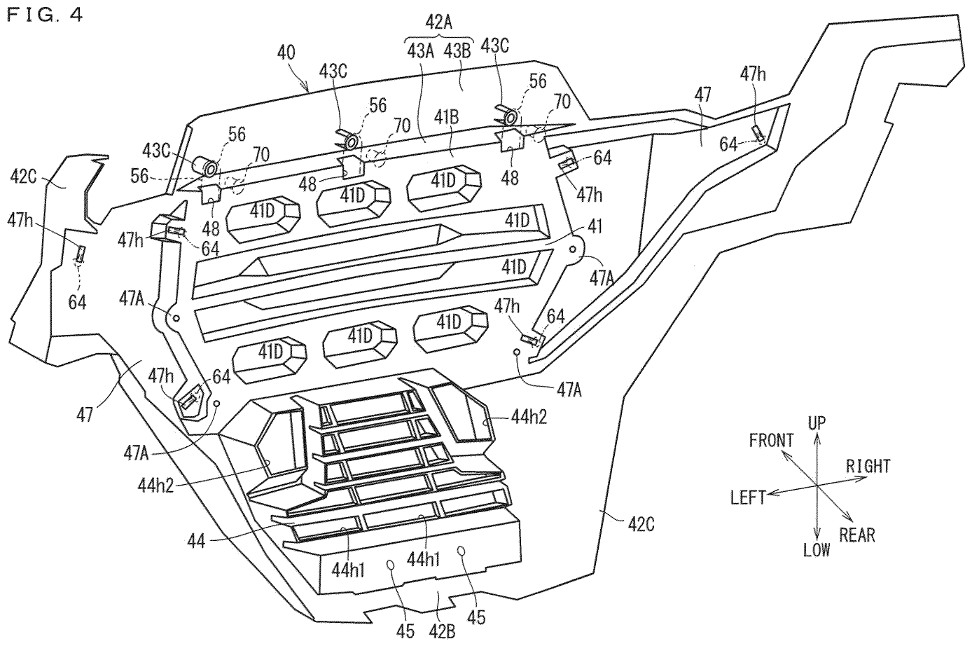

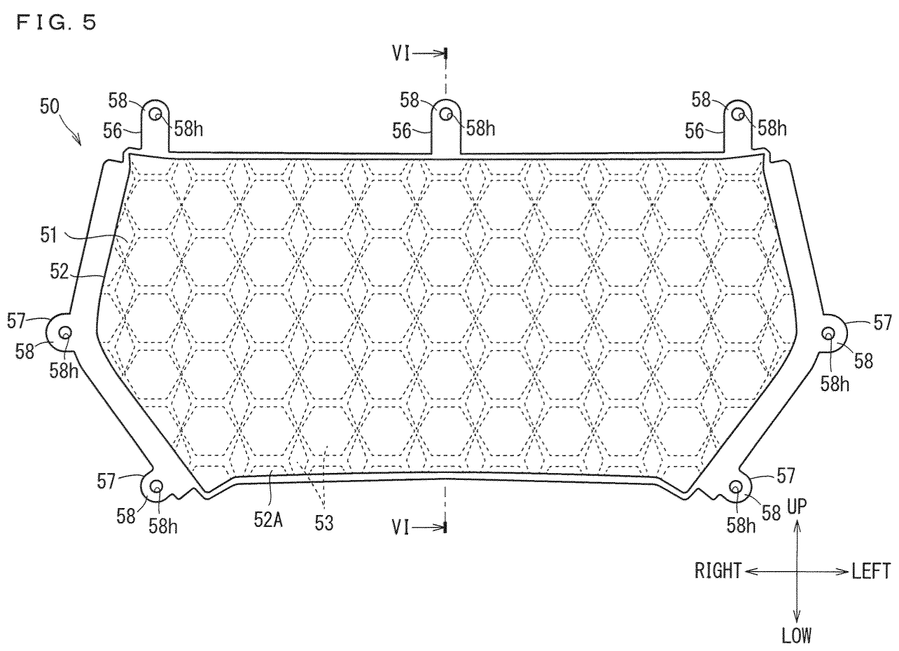

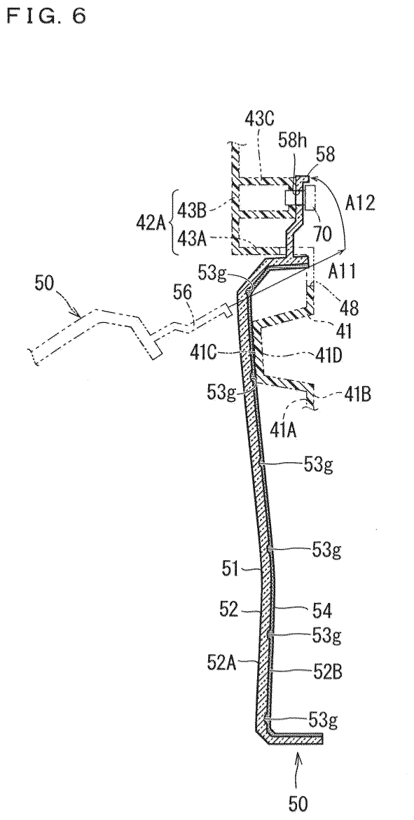

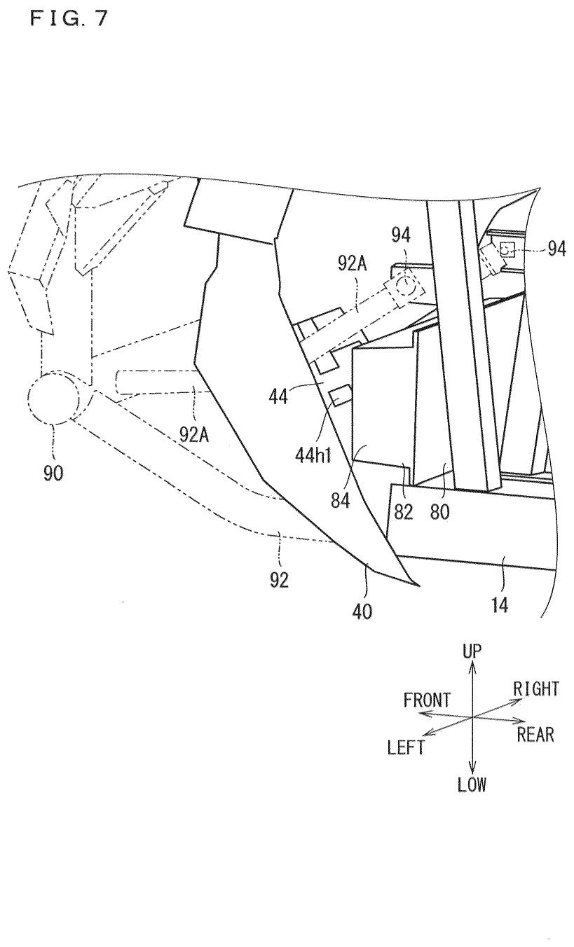

Described in more detail is a configuration of a front part where the front design cover 16b is provided in the vehicle 10. FIG. 2 is a front perspective view illustrating the front part of the vehicle 10. FIG. 3 is an exploded perspective view illustrating the front design cover 16b. FIG. 4 is a back perspective view illustrating the first design cover 40. FIG. 5 is a front view illustrating the second design cover 50. FIG. 6 is a cross-sectional view along an VI-VI line in FIG. 5. FIG. 7 is a back perspective view illustrating a lower part of the front part of the vehicle 10.

The front design cover 16b includes the first design cover 40 and the second design cover 50. Herein, the front design cover 16b includes a third design cover 60. The first design cover 40, the second design cover 50, and the third design cover 60 are components different from each other. Each of the first design cover 40, the second design cover 50, and the third design cover 60 is made up of resin, for example. Each of the first design cover 40, the second design cover 50, and the third design cover 60 is a molded component formed by injection molding or press working on a plate member, for example.

The first design cover 40 has a larger area than the second design cover 50 and the third design cover 60. The second design cover 50 and the third design cover 60 cover the first design cover 40 from the front side. Herein, the second design cover 50 and the third design cover 60 are provided in regions adjacent to each other. Herein, the second design cover 50 is located in a center of the vehicle 10 in the vehicle width direction, and the third design cover 60 is located on both lateral sides of the second design cover 50. The first design cover 40 and the second design cover 50 are formed into shapes bilaterally symmetric with respect to a center in the right-left direction. One of the pair of third design covers 60 is formed into a shape bilaterally symmetrical to the other one thereof. A major part of the first design cover 40 covered by the second design cover 50 and a major part of a region covered by the third design cover 60 are different from each other. A part of the third design cover 60 covers the first design cover 40 and the second design cover 50.

Each of the second design cover 50 and the third design cover 60 is attached to the first design cover 40. Herein, the second design cover 50 is fixed to the vehicle body 12 via the first design cover 40. A part where the first design cover 40 and the second design cover 50 are fixed to each other is an example of a fixing part for fixing the second design cover 50 to the vehicle body 12. Fastening parts 56 and 57 in the second design cover 50 attached to the first design cover 40 are examples of a fixing part constituting the fixing part. A member other than the second design cover 50 may have a configuration constituting the fixing part. For example, the first design cover 40 and the vehicle body 12 may also include a part constituting the fixing part. For example, a part where the first design cover 40 and the vehicle body 12 are fixed can also be considered to constitute the fixing part for fixing the second design cover to the vehicle body 12. Fastening by a fastening member is used herein as a fixing state of the second design cover 50. However, the fixing state of the second design cover 50 is not limited to fastening, but insertion or locking, for example, may also be applicable. Herein, the second design cover 50 is attached to the first design cover 40 prior to the third design cover 60. The third design cover 60 covers the fastening part 57 of the second design cover 50 from the front side.

The first design cover 40 includes an inner design part 41 and protrusion parts 42 and 47. The inner design part 41 is a part mainly covered by the second design cover 50. The protrusion parts 42 and 47 are parts protruding from the inner design part 41 to a direction intersecting with the front-back direction. Herein, a part protruding to an up-down direction from the inner design part 41 and a part protruding to the right-left direction are provided as the protrusion parts 42 and 47.

Herein, the inner design part 41 is located in the center along the right-left direction of the vehicle 10. The inner design part 41 planarly extends along the up-down direction and the right-left direction. The inner design part 41 includes a front surface 41A and a rear surface 41B. The front surface 41A and the rear surface 41B is a front surface and a rear surface of the first design cover 40. The front surface and the rear surface of the first design cover 40 are also referred to as the front surface 41A and the rear surface 41B in some cases. The front surface 41A of the inner design part 41 is a design surface of the inner design part 41. The inner design part 41 is made up of opaque resin. Herein, the first design cover 40 including the inner design part 41 is made up of opaque resin. A design of the inner design part 41 includes an uneven shape part 41C provided to the front surface 41A. A corresponding uneven shape part 41D corresponding to the uneven shape part 41C of the front surface 41A is formed in the rear surface 41B. An uneven relationship is opposite to each other between the uneven shape part 41C and the corresponding uneven shape part 41D. Specifically, as illustrated in FIG. 6, when a shape of the uneven shape part 41C of the front surface 41A is a convex part 41C, a shape of the corresponding uneven shape part 41D on a rear side of the convex part 41C is a concave part 41D. A protrusion dimension of the convex part 41C in the front-back direction may be larger than a thickness dimension of a plate member constituting the inner design part 41, for example.

The protrusion parts 42 and 47 include a protrusion design part 42 and a cover target part 47. The protrusion design part 42 is a part which is not covered by any of the second design cover 50 and the third design cover 60 but appears as a design on a front side of the vehicle 10. The cover target part 47 is a part covered by the third design cover 60.

The protrusion design part 42 includes an upper part 42A, a lower part 42B, and a side part 42C. The upper part 42A is a part protruding to an upper side from an upper edge of the inner design part 41. The lower part 42B is a part protruding to an lower side from a lower edge of the inner design part 41. The side part 42C is a part protruding to a lateral side from a side edge of the lower part 42B.

The upper part 42A includes a front flared part 43A flared to the front side from the upper edge of the inner design part 41 and an upper flared part 43B flared to the upper side from the front edge of the front flared part 43A. An attachment receiving part 43C for attaching the second design cover 50 is formed in the rear surface 41B of the upper flared part 43B. An upper fastening receiving part 43C for receiving a fastening member 70 is provided as the attachment receiving part 43C. The fastening member 70 is fastened to the upper fastening receiving part 43C from the rear side.

An insertion hole 48 for inserting a part of the second design cover 50 is formed in the first design cover 40. Herein, the insertion hole 48 is formed in a part where the inner design part 41 and the upper part 42A are connected. The insertion hole 48 is formed from an upper edge of the inner design part 41 to a base end of the front flared part 43A A part of the insertion hole 48 formed on the upper edge of the inner design part 41 passes through the inner design part 41 in the front-back direction. A part of the insertion hole 48 formed in the front flared part 43A passes through the front flared part 43A in the up-down direction.

A frame connection part 45 is provided to the lower part 42B. The frame connection part 45 is connected to a distal end of a lower frame of the frame 14. The frame connection part 45 is fastened to the lower frame by the fastening member 70, for example. The frame connection part 45 is a hole for passing the fastening member 70, for example. Herein, two holes are formed. Two holes are spaced apart from each other in the right-left direction. Each hole passes through the lower part 42B along the front-back direction. The fastening member 70 in the frame connection part 45 is fastened along the front-back direction.

The side part 42C is located on both lateral sides of the lower part 42B. Each side part 42C passes a lateral side of the cover target part 47 from the side edge of the lower part 42B, and extends toward the upper side. A frame connection part 46 is provided to a distal end of the side part 42C. The frame connection part 46 is connected to an upper frame of the frame 14 or a bracket extending from the upper frame, for example. The frame connection part 46 is a hole for passing the fastening member 70, for example. Herein, one hole is formed in each frame connection part 46. The hole passes through the side part 42C along the up-down direction. The fastening member 70 in the frame connection part 46 is fastened along the up-down direction.

The cover target part 47 is a part protruding to a lateral side from a side edge of the inner design part 41. The cover target part 47 is provided to both lateral sides of the inner design part 41. The attachment receiving part 47A for attaching the second design cover 50 and the attachment receiving part 47h for attaching the third design cover 60 are formed in the front surface 41A of each cover target part 47. A lateral fastening receiving part 47A for receiving the fastening member 70 is provided as the attachment receiving part 47A for the second design cover 50. The fastening member 70 is fastened to the lateral receiving fastening part 47A from the front side. A locking hole 47h is formed as the attachment receiving part 47h for the third design cover 60. The locking hole 47h passes through the cover target part 47 along the front-back direction. Two lateral fastening receiving parts 47A and three locking holes 47h are formed in one cover target part 47. Two lateral fastening receiving parts 47A are spaced apart from each other in the up-down direction. Three locking holes 47h are dispersedly disposed to form vertexes of a triangle.

The upper part 42A is located between a pair of headlights 18. A lateral edge of the upper part 42A extends along a lateral edge of an inner side of the headlight 18 in the right-left direction. An upper edge of the cover target part 47 extends along a lower edge of the headlight 18. The side part 42C includes a part located above the cover target part 47. A lateral edge of the side part 42C in the right-left direction extends along a lateral edge of an outer side of the headlight 18 in the right-left direction.

The upper part 42A supports a front end of the hood 17 from the lower side. An upper edge of the upper part 42A extends along a front edge of the hood 17. The side part 42C includes a part located in back of an irradiation surface the headlight 18. The part supports a lateral end of the hood 17 from the lower side. An upper edge of the part extends along the lateral edge of the hood 17.

The second design cover 50 includes an outer design part 51 and fastening parts 56 and 57. The fastening parts 56 and 57 protrude from the outer design part 51 to a direction intersecting with the front-back direction. The fastening parts 56 and 57 are fastened to the first design cover 40.

Herein, the outer design part 51 is located in the center along the right-left direction of the vehicle 10. The outer design part 51 planarly extends along the up-down direction and the right-left direction. The inner design part 41 and the outer design part 51 are overlapped with each other in the front-back direction. The outer design part 51 is located in front of the inner design part 41. The outer design part 51 includes a base member 52.

The base member 52 is made up of semitransparent resin. The base member 52 includes a front surface 52A and a rear surface 52B. A design of the outer design part 51 includes a colored layer 54 provided to the rear surface 52B or an uneven shape part 53. Herein, the design of the outer design part 51 includes both the colored layer 54 provided to the rear surface 52B and the uneven shape part 53. Herein, the front surface 52A of the base member 52 is a design surface exposed to the front side in the vehicle 10. Since the base member 52 is made up of semitransparent resin, the colored layer 54 provided to the rear surface 52B or the uneven shape part 53 is observed from the front side of the vehicle 10.

The colored layer 54 is stacked on the rear surface 52B. The colored layer 54 has a color different from the base member 52. The colored layer 54 forms a color design. The colored layer 54 may be made up of a colorant such as ink applied to the rear surface 52B. The colored layer 54 may be made up of a decorative seat attached to the rear surface 52B.

The uneven shape part 53 is formed in the rear surface 52B. The uneven shape part 53 forms a shape design. Herein, the uneven shape part 53 expresses a pattern. The pattern is not particularly limited but can be appropriately set. In the example illustrated in FIG. 5, the pattern has a shape of a combination of hexagon and rhombus. As illustrated in FIG. 6, the uneven shape part 53 includes a groove 53g formed in the rear surface 52B herein. The pattern of the outer design part 51 is formed by the groove 53g. A part between hexagon and rhombus or an inner part of each of hexagon and rhombus may be the groove 53g.

The front surface 52A is formed more smoothly than the rear surface 52B. A corresponding uneven shape part corresponding to the uneven shape part 53 is not formed in the front surface 52A. Herein, the front surface 52A is formed into a concave surface shape in which an intermediate part is concaved more backward than both end portions in the up-down direction. Herein, the front surface 52A is formed into a convex surface shape in which the intermediate part protrudes more forward than both end portions in the right-left direction.

As illustrated in FIG. 6, the inner design part 41 is located in back of the rear surface 52B. The convex part 41C and the rear surface 52B of the inner design part 41 may be spaced apart from each other, or may also have contact with each other along the front-back direction.

Herein, the upper fastening part 56 and the lateral fastening part 57 are provided as the fastening parts 56 and 57. The upper fastening part 56 protrudes from the outer design part 51 to the upper side. The lateral fastening part 57 protrudes from the outer design part 51 to the lateral side. The second design cover 50 includes a first fixing part and a second fixing part fixed to positions different from each other in the vehicle body 12. The first design cover 40 covers the first fixing part. The third design cover 60 covers the second fixing part. The upper fastening part 56 is an example of the first fixing part protruding from the second design cover 50 to the upper side. The lateral fastening part 57 is an example of the second fixing part protruding from the second design cover 50 to the lateral side.

Each of the fastening parts 56 and 57 includes a fastening piece 58 in which the fastening hole 58h is formed. The fastening parts 56 and 57 are examples of the fixing parts, the fastening piece 58 is an example of a fixing piece, and the fastening hole 58h is an example of the fixing hole. The fastening piece 58 protrudes from the outer design part 51 in the up-down direction or the right-left direction. Herein, the fastening piece 58 is integrally formed with the base member 52. The fastening piece 58 may be a member different from the base member 52. The base member 52 includes a body part constituting the outer design part 51, a frame part provided to surround an outer periphery of the body part, and a fastening piece 58 protruding from the frame part.

The fastening member 70 is fastened to each fastening hole 58h. The fastening member 70 includes a fastening body 72 and a head 74 operated by an operator in fastening. When the fastening member 70 is fastened from the front side, the head 74 is located in front of the fastening body 72. When the fastening member 70 is fastened from the rear side, the head 74 is located in back of the fastening body 72. The fastening member 70 is a bolt, the fastening body 72 is a part in which a screw is cut in the bolt, and the head 74 is a bolt head, for example.

The fastening piece 58 of the upper fastening part 56 illustrated by a virtual line in FIG. 6 is in a state before being inserted into the insertion hole 48. For example, the fastening piece 58 is inserted into the insertion hole 48 along a direction of an arrow A11 in FIG. 6 while the second design cover 50 is in a posture of being inclined with respect to the first design cover 40. Then, when the second design cover 50 is rotated along a direction of an arrow A12 in FIG. 6 after the fastening piece 58 is inserted into the insertion hole 48, the fastening hole 58h of the upper fastening part 56 is located in back of the upper fastening receiving part 43C provided to the rear surface 41B of the first design cover 40. When the fastening member 70 is fastened in this state, the upper fastening part 56 and the upper fastening receiving part 43C are fastened to each other. A base end of the fastening piece 58 passes through the insertion hole 48 while the upper fastening part 56 and the upper fastening receiving part 43C are fastened to each other. When the fastening hole 58h of the upper fastening part 56 is located in back of the upper fastening receiving part 43C, the fastening hole 58h of the lateral fastening part 57 is located in front of the lateral fastening receiving part 47A.

The third design cover 60 covers the cover target part 47 from the front side. The third design cover 60 is located below the headlight 18. The attachment part 64 attached to the attachment receiving part 47h of the first design cover 40 is provided to the rear surface of the third design cover 60. Herein, the attachment part 64 is a clip 64 inserted and locked to the locking hole 47h. For example, the clip 64 includes a mushroom head, and can be attached and detached by being pressed and pulled.

The vehicle 10 includes cover parts 43B and 62. The cover parts 43B and 62 are parts located adjacent to the outer design part 51 to cover the fastening parts 56 and 57 from the front side. Herein, the cover parts 43B and 62 include a side cover part 62 and an upper cover part 43B.

The side cover part 62 is located on a lateral side of the outer design part 51. The side cover part 62 covers the lateral fastening part 57. The side cover part 62 is provided to the third design cover 60. The lateral fastening part 57 covered by the third design cover 60 is fastened from the front side of the vehicle 10. The head 74 of the fastening member 70 fastened to the lateral fastening part 57 is located in front of the fastening body 72.

The upper cover part 43B is located above the outer design part 51. The upper cover part 63 covers the upper fastening part 56. The upper cover part 43B is provided to the protrusion design part 42 of the first design cover 40. Herein, the upper flared part 43B described above constitutes the upper cover part 43B. The upper fastening part 56 covered by the protrusion design part 42 is fastened from the rear side of the vehicle 10. The head 74 of the fastening member 70 fastened to the upper fastening part 56 is located in back of the fastening body 72.

The vehicle 10 includes a grill part 44 and an air cool target component 80 located in back of the grill part 44. The grill part 44 is located in a lower part than the inner design part 41 and the outer design part 51. Herein, the inner design part 41 and the grill part 44 integrally constitute the first design cover 40. The grill part 44 is provided to the lower part 42B of the first design cover 40. The frame connection part 45 of the lower part 42B is located below the grill part 44. Holes are formed in the grill part 44. The holes in the grill part 44 pass through the first design cover 40 in the front-back direction. The holes include air cool holes 44h1 and guard insertion holes 44h2. The pair of guard insertion holes 44h2 are located at an interval in the right-left direction. The air cool hole 44h1 is formed between the pair of guard insertion holes 44h2 and below the pair of guard insertion holes 44h2. A peripheral edge part of the air cool hole 44h1 extends in a lattice form.

The air cool target component 80 is a heat generating component. The air cool target component 80 is component preferably air-cooled by a traveling wind. The air cool target component 80 may be a component for radiating heat in a travel driving part. When the vehicle 10 is an electrical vehicle, the air cool target component 80 may be a component for radiating heat in the travel battery 32. When the vehicle 10 is a vehicle including an internal combustion engine, the air cool target component 80 may be a radiator, for example. The vehicle 10 may include a thermal conductive member transmitting heat in a travel driving part to the air cool target component 80.

The air cool target component 80 includes a case 82. The case 82 is supported by the frame 14, for example. A heat radiation part 84 is provided to a front part of the case 82. The air cool hole 44h1 is located in front of the heat radiation part 84. The traveling wind passes through the air cool hole 44h1 and reaches the heat radiation part 84. The heat radiation part 84 may include fins. The fin is formed into a plate-like shape. The fins are arranged side by side at intervals in a plate thickness direction. The plate thickness direction extends along in a direction intersecting with the front-back direction (the right-left direction or the up-down direction, for example). Accordingly, an area receiving the traveling wind can be increased.

As illustrated in FIG. 7, the vehicle 10 may include a front guard 90. The front guard 90 is a component protecting the vehicle body 12 from a collision of the front side of the vehicle 10. The front guard 90 is attached to be located in front of the front design cover 16b. The front guard 90 is also referred to as a grill guard, for example. The front guard 90 is supported by the frame 14, for example.

The front guard 90 is made by connecting a plurality of pipes 92 to each other, for example. The plurality of pipes 92 include a pipe 92 extending along the front-back direction. The pipe 92 passes through the guard insertion hole 44h2. A back end of the pipe 92 extends in back of the front design cover 16b. The frame connection part 94 is provided to the back end of the pipe 92. The frame connection part 94 is connected to upper and lower frames extending along the up-down direction in the frame 14 or the bracket protruding from the upper and lower frames. The front guard 90 may include a part co-fastened to the frame 14 together with the frame connection part 45 of the front design cover 16b as a part supported by the frame 14 in addition to the pipe 92.

For example, the first design cover 40, the second design cover 50, and the third design cover 60 are assembled in a state before the front design cover 16b is connected to the frame 14. The second design cover 50 is assembled to the first design cover 40 via the fastening parts 56 and 57. Subsequently, the third design cover 60 is assembled to the first design cover 40 via the clip 64. Accordingly, the front design cover 16b is completed, and is connected to the frame 14 in this state.

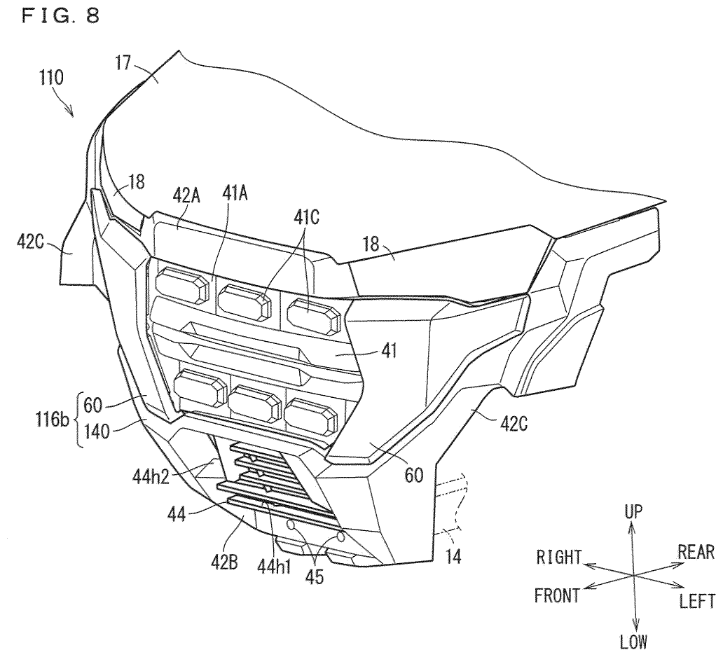

FIG. 8 is a front perspective view illustrating a front side part of a vehicle 110 with no second design cover 50.

Multiple models in which some design is common and the other some design is different from each other are developed as a vehicle in some cases. The vehicle 10 described above is distributed and used with the second design cover 50. The vehicle 110 illustrated in FIG. 8 is distributed and used with no second design cover 50. A front design cover 116b of the vehicle 110 includes a first design cover 140 and the third design cover 60, but does not include the second design cover 50. A design of the first design covers 40 and 140 and a design of the third design cover 60 are common in the vehicle 10 and the vehicle 110. Presence or absence of the second design cover 50 is different between the vehicle 10 and the vehicle 110. In development of the vehicles 10 and 110 with a plurality of models, set are the vehicle 110 of a model with no second design cover 50 and the vehicle 10 of a model with the second design cover 50. The inner design part 41 of the first design cover 40 is commonalized in the vehicles 10 and 110 with the models; thus, increase in cost can be suppressed. The design of the front design covers 16b and 116b can be easily changed depending on presence or absence of the second design cover 50.

In the vehicle 110 of the model in which the second design cover 50 is not provided, a part for attaching the second design cover 50 may be or may not be omitted in the first design cover 140. When the part is provided to an exposed position, the part is preferably omitted. For example, the insertion hole 48 described above may be omitted in the first design cover 140 for the vehicle 110. For example, a part for opening the insertion hole 48 may be a different component in a mold. In manufacturing the first design cover 40 for the vehicle 10, a mold to which the different component is attached may be used, and in manufacturing the first design cover 140 for the vehicle 110, a mold in which the different component is omitted may be used. Accordingly, in manufacturing two types of the first design covers 40 and 140 in which presence or absence of the insertion hole 48 is different, a major part of the mold can be commonalized, and increase in manufacturing cost can be suppressed.

According to the vehicle 10 having the above configuration, a design of the front surface of the vehicle 10 is easily changed by the outer design part 51 of the second design cover 50. In developing the vehicles 10 and 110 with a plurality of models, set are the vehicle 110 of the model with no second design cover 50 and the vehicle 10 of the model with the second design cover 50, and the inner design part 41 of the first design covers 40 and 140 is commonalized in the vehicles 10 and 110 with the models; thus, increase in cost can be suppressed.

The second design cover 50 includes the fastening parts 56 and 57 protruding from the outer design part 51 along the direction intersecting with the front-back direction, and the vehicle 10 includes the cover parts 43B and 62 located adjacent to the outer design part 51 to cover the fastening parts 56 and 57. Accordingly, the fastening parts 56 and 57 of the second design cover 50 can be hidden by the cover parts 43B and 62.

The lateral fastening part 57 protrudes from the outer design part 51 to the lateral side, and the cover parts 43B and 62 includes the side cover part 62 located on the lateral side of the outer design part 51. Accordingly, the lateral fastening part 57 of the second design cover 50 can be hidden on the lateral side of the outer design part 51.

The upper fastening part 56 protrudes from the outer design part 51 to the upper side, and the cover parts 43B and 62 include the upper cover part 43B located above the outer design part 51. Accordingly, the upper fastening part 56 of the second design cover 50 can be hidden above the outer design part 51.

The vehicle 10 includes the third design cover 60 as the component different from the first design cover 40 and the second design cover 50, and the cover part 62 is provided to the third design cover 60. Accordingly, the fastening part 56 of the second design cover 50 can be hidden by the third design cover 60 as the component different from the first design cover 40 and the second design cover 50.

The fastening part 56 covered by the third design cover 60 is fastened from the front side of the vehicle 10. Accordingly, the fastening part 56 fastened from the front side of the vehicle 10 can be hidden by the third design cover 60.

The first design cover 40 includes the protrusion design part 42 protruding from the inner design part 41 located in back of the outer design part 51 along the direction intersecting with the front-back direction, and the cover part 43B is provided to the protrusion design part 42 (the upper part 42A herein). Accordingly, the fastening part 57 can be hidden by the protrusion design part 42 of the first design cover 40.

The fastening part 57 covered by the protrusion design part 42 is fastened from the rear side of the vehicle 10. Accordingly, the fastening part 57 fastened from the rear side of the vehicle 10 can be hidden by the protrusion design part 42.

The insertion hole 48 is formed in the first design cover 40, the fastening part 57 includes the fastening piece 58 protruding from the outer design part 51 and the fastening hole 58h formed in the distal end of the fastening piece 58, and the base end of the fastening piece 58 passes through the insertion hole 48. Accordingly, the fastening hole 58h is easily located on the rear side of the protrusion design part 42 of the first design cover 40.

The cover parts 43B and 62 include the side cover part 62 located on the lateral side of the outer design part 51 and the upper cover part 43B located above the outer design part 51. Accordingly, the fastening parts 56 and 57 of the second design cover 50 can be hidden on the lateral side of and above the second design cover 50.

The side cover part 62 is provided to the third design cover 60, and the upper cover part 43B is provided to the protrusion design part 42. Accordingly, the fastening part 56 on the lateral side of the outer design part 51 can be hidden by the third design cover 60 as the component different from the first design cover 40 and the second design cover 50, and the fastening part 57 above the outer design part 51 can be hidden by the protrusion design part 42 of the first design cover 40.

The vehicle 10 includes the grill part 44 located in a lower part than the inner design part 41 and the outer design part 51 and the air cool target component 80 located in back of the grill part 44. Accordingly, the grill part 44 can be provided in a position different from the inner design part 41 and the outer design part 51 in the front surface of the vehicle 10, and the air cool target component 80 can be effectively air-cooled.

The inner design part 41 and the grill part 44 integrally constitute the first design cover 40, and the grill part 44 extends from the lower edge of the inner design part 41 to the lower side. Accordingly, the grill part 44 and the inner design part 41 can be one component.

The outer design part 51 includes the base member 52 made up of semitransparent resin. Accordingly, the design of the outer design part 51 is easily formed by coloring the base member 52.

The base member 52 includes the front surface 52A and the rear surface 52B, and the rear surface 52B includes the uneven shape part 53. In this case, since the rear surface 52B is located on the inner side of the vehicle 10 than the front surface 52A, the uneven shape part 53 is hardly damaged.

The front surface 52A is formed more smoothly than the rear surface 52B. Accordingly, improved is an outer appearance of the uneven shape part 53 provided to the rear surface 52B of the base member 52 when seen from the front surface 52A.

The inner design part 41 includes the front surface 41A and the rear surface 41B, and is made up of opaque resin, and the design of the inner design part 41 includes the uneven shape part 41C provided to the front surface 41A. Accordingly, cost on the inner design part 41 can be suppressed.

### Modification Example

The vehicle may be a versatile small vehicle more suitable for travel on a limited off-road area rather than for fast travel on a public road, for example. The off-road vehicle may be a side-by-side vehicle, for example. The side-by-side vehicle is a small vehicle suitable for all terrain travel, particularly for off-road travel, and is a vehicle in which occupants can be seated side by side, for example. The side-by-side vehicle may be a multipurpose off-highway utility vehicle (MOHUV) defined by ANSI/OPEI B71.9-2016 and a recreational off-highway vehicle defined by ANSI/ROHVA 1-2016, for example.

The vehicle may be a passenger transport vehicle. The passenger transport vehicle may be a vehicle for a purpose of traveling a limited area at a low speed. Examples of the limited area may include limited community areas, private roads, and private lands (e.g., golf courses and parks) which is not a public road. The limited community areas may also be areas provided for use by community residents. The community areas are, for example, areas including houses and public facilities (e.g., schools and hospitals), and are areas in which a passenger transport vehicle designed not to travel along a public road is permitted to travel at a low speed. The low speed is, for example, a speed with an upper limit ranging from 20 mph to 30 mph. Examples of the passenger transport vehicle include a personal transport vehicle (PTV) in accordance with ANSI/ILTVA Z135, and a golf cart in accordance with ANSI/ILTVA Z130.1. The examples of the passenger transport vehicle include a personal transportation electric vehicle.

### Appendix

The present application discloses the following aspects.
A first aspect is a vehicle including: a vehicle body; a seat supported by the vehicle body; a dashboard disposed in a front end of an occupant space in which the seat is disposed; a first design cover including an inner design part located in front of the dashboard; and a second design cover including an outer design part located in front of the inner design part.

According to the vehicle, a design of a front surface of the vehicle is easily changed by the outer design part of the second design cover. In developing a vehicle with a plurality of models, set are a vehicle of a model with no second design cover and a vehicle of a model with the second design cover, and the inner design part of the first design cover is commonalized in the vehicle with the models; thus, increase in cost can be suppressed.
A second aspect is the vehicle according to the first aspect including a cover part covering a fixing part for fixing the second design cover to the vehicle body.
A third aspect is the vehicle according to the second aspect, wherein the second design cover includes a fixing part constituting the fixing part, the fixing part protrudes from the outer design part along a direction intersecting with a front-back direction, and the cover part is located adjacent to the outer design part to cover the fixing part.

Accordingly, the fixing part of the second design cover can be hidden by the cover part.
A fourth aspect is the vehicle according to the third aspect, wherein the fixing part protrudes from the outer design part to a lateral side, and the cover part includes a side cover part located on a lateral side of the outer design part.

Accordingly, the fixing part of the second design cover can be hidden on the lateral side of the outer design part.
A fifth aspect is the vehicle according to the third or fourth aspect, wherein the fixing part protrudes from the outer design part to an upper side, and the cover part includes an upper cover part located above the outer design part.

Accordingly, the fixing part of the second design cover can be hidden above the outer design part.
A sixth aspect is the vehicle according to any one of the second to fifth aspects including a third design cover as a component different from the first design cover and the second design cover, wherein the cover part is provided to the third design cover.

Accordingly, the fixing part of the second design cover can be hidden by the third design cover as the component different from the first design cover and the second design cover.
A seventh aspect is the vehicle according to the third aspect including a third design cover as a component different from the first design cover and the second design cover, wherein the cover part is provided to the third design cover, and the fixing part covered by the third design cover is fixed from a front side of a vehicle.

Accordingly, the fixing part fixed from the front side of the vehicle can be hidden by the third design cover.
An eighth aspect is the vehicle according to any one of the second to seventh aspects, wherein the first design cover includes a protrusion design part protruding from the inner design part located on a rear side of the outer design part along a direction intersecting with a front-back direction, and the cover part is provided to the protrusion design part.

Accordingly, the fixing part can be hidden by the protrusion design part of the first design cover.
A ninth aspect is the vehicle according to the third aspect, wherein the first design cover includes a protrusion design part protruding from the inner design part located on a rear side of the outer design part along a direction intersecting with a front-back direction, the cover part is provided to the protrusion design part, and the fixing part covered by the protrusion design part is fixed from a rear side of a vehicle.

Accordingly, the fixing part fixed from the rear side of the vehicle can be hidden by the protrusion design cover.
A tenth aspect is the vehicle according to the third aspect, wherein the first design cover includes a protrusion design part protruding from the inner design part located on a rear side of the outer design part along a direction intersecting with a front-back direction, an insertion hole is formed in the first design cover, the fixing part includes a fixing piece protruding from the outer design part and a fixing hole formed in a distal end of the fixing piece, and a base end of the fixing piece passes through the insertion hole.

Accordingly, the fixing hole is easily located on the rear side of the protrusion design part of the first design cover.
An eleventh aspect is the vehicle according to any one of the second to ninth aspects, wherein the cover part includes a side cover part located on a lateral side of the outer design part and an upper cover part located on an upper side of the outer design part.

Accordingly, the fixing part of the second design cover can be hidden on the lateral side of and above the second design part.
A twelfth aspect is the vehicle according to the eleventh aspect including a third design cover as a component different from the first design cover and the second design cover, wherein the first design cover includes a protrusion design part protruding from the inner design part located on a rear side of the outer design part to an upper side, the side cover part is provided to the third design cover, and the upper cover part is provided to the protrusion design part.

Accordingly, the fixing part on the lateral side of the outer design part can be hidden by the third design cover as the component different from the first design cover and the second design cover, and the fixing part above the outer design part can be hidden by the protrusion design part of the first design cover.
A thirteenth aspect is the vehicle according to any one of the first to twelfth aspects including a grill part located on a lower part than the inner design part and the outer design part and an air cool target component located on a rear side of the grill part.

Accordingly, the grill part can be provided in a position different from the inner design part and the outer design part in the front surface of the vehicle, and the air cool target component can be effectively air-cooled.
A fourteenth aspect is the vehicle according to the thirteenth aspect, wherein the inner design part and the grill part integrally constitute the first design cover, and the grill part extends from a lower edge of the inner design part to a lower side.

Accordingly, the grill part and the inner design part can be one component.
A fifteenth aspect is the vehicle according to any one of the first to fourteenth aspects, wherein the outer design part includes a base member made up of semitransparent resin.

Accordingly, the design of the outer design part is easily formed by coloring the base member, for example.
A sixteenth aspect is the vehicle according to the fifteenth aspect, wherein the base member includes a front surface and a rear surface, the rear surface includes an uneven shape part, and the front surface is formed more smoothly than the rear surface.

Since the rear surface is located on the inner side of the vehicle than the front surface, the uneven shape part is hardly damaged. Since the front surface is formed more smoothly than the rear surface, improved is an outer appearance of the uneven shape part provided to the rear surface of the base member when seen from the front surface.
A seventeenth aspect is the vehicle according to any one of the first to sixteenth aspects, wherein the inner design part includes a front surface and a rear surface and is made up of opaque resin, and a design of the inner design part includes an uneven shape part provided to the front surface.

Accordingly, cost on the inner design part can be suppressed.
An eighteenth aspect is the vehicle according to any one of the first to seventeenth aspects including a third design cover as a component different from the first design cover and the second design cover, wherein the second design cover includes a first fixing part and a second fixing part fixed to positions different from each other in the vehicle body, the first design cover covers the first fixing part, and the third design cover covers the second fixing part.

Accordingly, the fixing parts in the positions can be covered by the different design covers.
A nineteenth aspect is the vehicle according to the eighteenth aspect, wherein the first fixing part of the second design cover includes an upper fastening part protruding from the second design cover to an upper side, and the second fixing part of the second design cover includes a lateral fastening part protruding from the second design cover to a lateral side.

The foregoing description is in all aspects illustrative and does not restrict the present invention. Numerous modifications and variations that have not yet been exemplified are devised without departing from the scope of the present invention.

1. A vehicle, comprising:
a vehicle body;
a seat supported by the vehicle body;
a dashboard disposed in a front end of an occupant space in which the seat is disposed;
a first design cover including an inner design part located in front of the dashboard; and
a second design cover including an outer design part located in front of the inner design part.

2. The vehicle according to claim 1, comprising
a cover part covering a fixing part for fixing the second design cover to the vehicle body.

3. The vehicle according to claim 2, wherein
the second design cover includes a fixing part constituting the fixing part,
the fixing part protrudes from the outer design part along a direction intersecting with a front-back direction, and
the cover part is located adjacent to the outer design part to cover the fixing part.

4. The vehicle according to claim 3, wherein
the fixing part protrudes from the outer design part to a lateral side, and
the cover part includes a side cover part located on a lateral side of the outer design part.

5. The vehicle according to claim 3, wherein
the fixing part protrudes from the outer design part to an upper side, and
the cover part includes an upper cover part located above the outer design part.

6. The vehicle according to claim 2, comprising
a third design cover as a component different from the first design cover and the second design cover, wherein
the cover part is provided to the third design cover.

7. The vehicle according to claim 3, comprising
a third design cover as a component different from the first design cover and the second design cover, wherein
the cover part is provided to the third design cover, and
the fixing part covered by the third design cover is fixed from a front side of a vehicle.

8. The vehicle according to claim 2, wherein
the first design cover includes a protrusion design part protruding from the inner design part located on a rear side of the outer design part along a direction intersecting with a front-back direction, and
the cover part is provided to the protrusion design part.

9. The vehicle according to claim 3, wherein
the first design cover includes a protrusion design part protruding from the inner design part located on a rear side of the outer design part along a direction intersecting with a front-back direction,
the cover part is provided to the protrusion design part, and
the fixing part covered by the protrusion design part is fixed from a rear side of a vehicle.

10. The vehicle according to claim 3, wherein
the first design cover includes a protrusion design part protruding from the inner design part located on a rear side of the outer design part along a direction intersecting with a front-back direction,
the cover part is provided to the protrusion design part,
an insertion hole is formed in the first design cover,
the fixing part includes a fixing piece protruding from the outer design part and a fixing hole formed in a distal end of the fixing piece, and
a base end of the fixing piece passes through the insertion hole.

11. The vehicle according to claim 2, wherein
the cover part includes a side cover part located on a lateral side of the outer design part and an upper cover part located on an upper side of the outer design part.

12. The vehicle according to claim 11, comprising
a third design cover as a component different from the first design cover and the second design cover, wherein
the first design cover includes a protrusion design part protruding from the inner design part located on a rear side of the outer design part to an upper side, and
the side cover part is provided to the third design cover, and the upper cover part is provided to the protrusion design part.

13. The vehicle according to claim 1, comprising:
a grill part located on a lower part than the inner design part and the outer design part; and
an air cool target component located on a rear side of the grill part.

14. The vehicle according to claim 13, wherein
the inner design part and the grill part integrally constitute the first design cover, and
the grill part extends from a lower edge of the inner design part to a lower side.

15. The vehicle according to claim 1, wherein
the outer design part includes a base member made up of semitransparent resin.

16. The vehicle according to claim 15, wherein
the base member includes a front surface and a rear surface,
the rear surface includes an uneven shape part, and
the front surface is formed more smoothly than the rear surface.

17. The vehicle according to claim 1, wherein
the inner design part includes a front surface and a rear surface and is made up of opaque resin, and
a design of the inner design part includes an uneven shape part provided to the front surface.

18. The vehicle according to claim 1, comprising
a third design cover as a component different from the first design cover and the second design cover, wherein
the second design cover includes a first fixing part and a second fixing part fixed to positions different from each other in the vehicle body,
the first design cover covers the first fixing part, and
the third design cover covers the second fixing part.

19. The vehicle according to claim 18, wherein
the first fixing part of the second design cover includes an upper fastening part protruding from the second design cover to an upper side, and
the second fixing part of the second design cover includes a lateral fastening part protruding from the second design cover to a lateral side.
